(19) United States
(12) Patent Application Publication
(10) Pub. No.: US 2022/0379938 A1
(43) Pub. Date: Dec. 1, 2022

(54) PROCESSING SYSTEM AND METHOD FOR CARRYING OUT TRACK WORK

(71) Applicant: ROBEL Bahnbaumaschinen GmbH, Freilassing (DE)

(72) Inventors: Gregor Schmid, Ainring (DE); Martin Knott, Freilassing (DE); Jan Flaemig, Traunstein (DE)

(21) Appl. No.: 17/886,048

(22) Filed: Aug. 11, 2022

Related U.S. Application Data
(63) Continuation of application No. PCT/EP2021/052745, filed on Feb. 5, 2021.

(30) Foreign Application Priority Data
Feb. 11, 2020 (DE) 10 2020 201 689.5

(51) Int. Cl. B61L 25/02; E01B 27/16; E01B 35/00; B64C 39/02

(52) U.S. Cl. CPC B61L 25/025; E01B 27/16; E01B 35/00; B64C 39/024; E01B 2203/12; B64C 2201/127

(57) ABSTRACT

A processing system for carrying out track work includes a rail vehicle having a processing device and a monitoring device for defining and monitoring a permissible working space for the rail vehicle. The processing system further includes a position measuring device for determining a position of the rail vehicle. The rail vehicle is controlled to carry out the track work by using a control device in dependence on the determined position and the defined working space. A method for carrying out track work is also provided.

### CROSS-REFERENCE TO RELATED APPLICATION

This application is a continuation, under 35 U.S.C. § 120, of copending International Patent Application PCT/EP2021/052745, filed Feb. 5, 2021, which designated the United States; this application also claims the priority, under 35 U.S.C. § 119, of German Patent Application DE 10 2020 201 689.5, filed Feb. 11, 2020; the prior applications are herewith incorporated by reference in their entirety.

### FIELD AND BACKGROUND OF THE INVENTION

The invention relates to a processing system and a method for carrying out track work.

A maintenance vehicle, which is known from U.S. Patent Application Publication No. 2019/016350 A1, delimits a protected working space by using a vehicle frame and side walls. Within the working space, track work is carried out by workers or by an industrial robot.

### SUMMARY OF THE INVENTION

It is accordingly an object of the invention to provide a processing system and a method for carrying out track work, which overcome the hereinafore-mentioned disadvantages of the heretofore-known systems and methods of this general type and which enable track work to be carried out automatically in a simple and safe manner.

With the foregoing and other objects in view there is provided, in accordance with the invention, a processing system for carrying out track work, having a rail vehicle including at least one processing device, a monitoring device for defining and monitoring a permissible working space for the rail vehicle, at least one position measuring device for determining a position of the rail vehicle, and a control device for controlling the rail vehicle in dependence on the determined position and the defined working space.

The rail vehicle is operated within the defined working space for carrying out the required track work. The working space is defined by using the monitoring device in at least one spatial direction, in particular in at least two spatial directions and in particular in three spatial directions. Preferably, the working space is defined in a horizontal x-direction corresponding to a longitudinal rail direction and/or in a horizontal y-direction corresponding to a transverse rail direction. When carrying out the track work, the position of the rail vehicle is determined by using the at least one position measuring device, and the displacement of the rail vehicle is controlled depending on the determined position by using the control device. In particular, the rail vehicle includes a chassis with a traction drive disposed thereon. The track work is thus carried out automatically in a simple manner by using the rail vehicle and the at least one processing device. During operation of the rail vehicle and the at least one processing device, there are in particular no persons, i.e. no driver and/or no worker, within the defined working space. The working space is monitored by using the monitoring device. If at least one working space boundary is violated by an incorrect movement of the rail vehicle and/or by an object entering the working space and/or by a person entering the working space, the rail vehicle or the traction drive and/or the at least one processing device is stopped. This ensures safe operation of the processing system.

The control device preferably includes a first control unit which is disposed outside the working space and a second control unit which is disposed inside the working space. In particular, the control device is disposed at least partially at the rail vehicle. The second control unit is disposed at the rail vehicle, for example. The control units are in signal communication with each other. Various processing programs are stored and selectable in the first control unit, for example. A selected processing program is transmitted to the second control unit, in which the processing program for carrying out the track work then runs. Signals from the at least one position measuring device and/or the monitoring device are transmitted to the first control unit and/or to the second control unit, so that the rail vehicle is stopped if an impermissible operating state is detected.

A processing system, in which the rail vehicle is configured for driverless and/or unattended operation, ensures automated carrying out of track work in a simple and safe manner. For driverless and/or unattended operation, the rail vehicle includes a sensor system for detecting the processing task or the object to be processed. Furthermore, the processing system includes a processing program implemented in the control device for processing the object to be processed by using the at least one processing device. Preferably, the rail vehicle further includes a sensor system for checking the processing result or the processed object.

A processing system including at least one sensor for controlling the at least one processing device ensures automated carrying out of track work in a simple and safe manner. The at least one sensor detects the processing task or the object to be processed and/or detects the processing result or the processed object. The at least one sensor thus enables driverless and/or unattended operation of the rail vehicle and the at least one processing device. The at least one sensor is disposed in particular at the rail vehicle, for example at the at least one processing device.

A processing system, in which the at least one processing device is configured as a multi-axis robot, ensures automated carrying out of track work in a simple and safe manner. The multi-axis robot is configured in particular as an industrial robot. The multi-axis robot preferably includes at least three movement axes, in particular at least four movement axes, in particular at least five movement axes and in particular six movement axes. The multi-axis robot includes in particular a tool mounting for receiving a tool.

A processing system, in which the at least one position measuring device is of non-contact configuration, ensures automated carrying out of track work in a simple and safe manner. The at least one position measuring device is, for example, in the form of a laser measuring device, a position signal receiver for a satellite-based position determination system and/or an optical measuring system for detecting measuring points disposed, for example, on catenary and/or signal poles. The at least one position measuring device is preferably at least partially attached to the rail vehicle.

A processing system, in which the at least one position measuring device is of mechanical configuration, ensures automated carrying out of track work in a simple and safe manner. The at least one position measuring device is at least partially attached to the rail vehicle. The at least one position measuring device is formed, for example, as a measuring cable attached to the rail vehicle and a monitoring unit for defining and monitoring the working space. The monitoring unit is attached to a sleeper of the track, for example, and delimits the working space in a horizontal x-direction or in a longitudinal rail direction. The monitoring unit is disposed, for example, centrally on a sleeper as viewed in the longitudinal rail direction. The monitoring unit includes, for example, a support frame to which the measuring cable is attached.

A processing system including a first position measuring device for providing a first position measuring signal and a second position measuring device for providing a second position measuring signal ensures automated carrying out of track work in a simple and safe manner. The two position measuring devices provide redundant position measurement. The position of the rail vehicle can be precisely determined from the two position measuring signals. In the event of failure and/or malfunction of one position measuring device, at least one safety measure can be initiated, such as generating a warning signal and/or stopping the carrying out of track work. Preferably, the position measuring devices provide the position measuring signals using different measuring methods. For example, the first position measuring device is based on a first measuring method, whereas the second position measuring device is based on a different second measuring method. This ensures a high reliability of the position determination and thus a high safety of the processing system.

A processing system, in which the monitoring device includes at least two monitoring units for being disposed on both sides of the rail vehicle, ensures automated carrying out of track work in a simple and safe manner. The at least two monitoring units delimit the working space for the rail vehicle in a horizontal x-direction. The horizontal x-direction corresponds to a longitudinal rail direction. The at least two monitoring units thus delimit the track section to be processed in the longitudinal rail direction. When the rail vehicle leaves the defined working space, the rail vehicle passes over one of the monitoring units. This is detected by the monitoring device so that the rail vehicle can be stopped by using the control device. In particular, the at least one position measuring device is partially attached to at least one of the monitoring units. For example, if the at least one position measuring device is configured as a measuring cable, the measuring cable is attached to one of the monitoring units. For example, in a configuration of the at least one position measuring device as a laser measuring apparatus, a reflector is attached to one of the monitoring units.

A processing system, in which the monitoring device includes at least one optical monitoring unit, ensures automated carrying out of track work in a simple and safe manner. By using the at least one optical monitoring unit, the space around the rail vehicle is detected. The monitoring device defines a working space within the detected space or the detection space. The at least one optical monitoring unit is disposed in particular in a vertical z-direction above the rail vehicle. The at least one optical monitoring unit is disposed, for example, at a crane and/or a flying object. The at least one optical monitoring unit includes, for example, a digital camera. The monitoring device preferably includes an image processing unit, so that image data determined by using the at least one optical monitoring unit can be evaluated and the defined working space can be monitored. For example, the image processing unit can be used to detect persons and/or objects entering the working space and to stop the rail vehicle or the traction drive and/or the at least one processing unit.

A processing system, in which the monitoring device includes at least one flying object, ensures automated carrying out of track work in a simple and safe manner. A monitoring unit is disposed on the at least one flying object, which detects a space around the rail vehicle. The monitoring unit is in particular configured to be optical. The monitoring device defines the working space for the rail vehicle within the detected space or a detection space. The size of the working space within the detected space can be changed depending on environmental influences. Unwanted movements of the at least one flying object depending on environmental influences, such as wind, can thus be compensated. Preferably, weather data is provided to the monitoring device. The size of the working space within the detected space can be changed depending on the provided weather data. In particular, the at least one flying object is configured as a drone.

The at least one flying object can be displaced depending on the position of the rail vehicle. Preferably, the at least one flying object is displaced synchronously with the rail vehicle. This creates a dynamic working space which enables the processing of long track sections.

The rail vehicle or the traction drive and/or the at least one processing device is stopped if an object and/or a person enters the working space and/or the at least one flying object no longer has sufficient energy to fly and must land and/or the rail vehicle is no longer detected.

In addition to a flying object having a monitoring unit for defining a working space for the rail vehicle, the monitoring device can include at least one further flying object having a monitoring unit. This monitoring unit monitors the track at a distance from the working space and the rail vehicle located therein. The distance is, for example, at least 1 km, in particular at least 2 km, and in particular at least 3 km. As a result, a rail vehicle approaching the working space, such as a passenger or freight train, can be detected at an early stage and emergency braking can be initiated. Preferably, the monitoring device has two further flying objects including associated monitoring units which are disposed on both sides of the working space.

A processing system including a safety device for mechanically stopping the rail vehicle outside the working space ensures automated carrying out of track work in a simple and safe manner. The safety device mechanically stops the rail vehicle if the rail vehicle leaves the working space in an uncontrolled manner. The safety device can be used, for example, to derail the rail vehicle. This reliably prevents the rail vehicle from leaving a construction site area.

A processing system including a tool magazine for providing tools for the at least one processing device ensures automated carrying out of track work in a simple and safe manner. The tool magazine is disposed in particular within the working space, preferably on the rail vehicle or next to the track. If different tools are required for carrying out track carried out, an automatic tool change can be carried out. The tool change is carried out, for example, by using the at least one processing device, which deposits a tool which is no longer required in the tool magazine and removes a new tool from the tool magazine. Alternatively, the processing system may additionally include a tool changer which carries out an automatic tool change.

A processing system including an energy supply device for energy supply ensures automated carrying out of track work in a simple and safe manner. The energy supply device preferably includes at least one energy storage device for providing electrical energy. The at least one energy storage device includes in particular at least one accumulator. The rail vehicle, in particular the traction drive and/or the at least one processing device, are preferably operated with electrical energy. In particular, at least one energy storage device is disposed on the rail vehicle, which provides electrical energy for a traction drive and/or a drive for the at least one processing device. The energy storage device is preferably replaceable and/or rechargeable. The energy supply device includes, for example, a charging station for recharging an energy storage device. The energy supply device can be connected to an overhead line, for example.

A processing system, in which the control device includes at least one emitter for emitting signals and/or at least one receiver for receiving signals, ensures automated carrying out of track work in a simple and safe manner. The control device is in signal communication with the at least one position measuring device and/or with the monitoring device. As a result, in the event of a malfunction and/or a violation of the working space, the rail vehicle or the traction drive and/or the at least one processing device can be stopped. The control device preferably includes a first control unit which is disposed outside the working space and a second control unit which is disposed inside the working space. The second control unit is preferably disposed on the rail vehicle. The first control unit and the second control unit are in signal communication with each other. As a result, signals can be transmitted from the first control unit to the second control unit and/or from the second control unit to the first control unit. The monitoring device and/or the at least one position measuring device is in signal communication with the first control unit and/or with the second control unit.

The invention is further based on the object of providing a method which enables track work to be carried out automatically in a simple and safe manner.

With the objects of the invention in view, there is concomitantly provided a method for carrying out track work, comprising the steps of:
providing a processing system according to the invention,
defining a working space by using the monitoring device,
moving the rail vehicle and carrying out track work within the defined working space,
wherein the position of the rail vehicle is determined by using the at least one position measuring device, and
wherein the rail vehicle is controlled by using the control device depending on the determined position and the defined working space.

The advantages of the method according to the invention correspond to the advantages of the processing system according to the invention already described.

Other features which are considered as characteristic for the invention are set forth in the appended claims.

Although the invention is illustrated and described herein as embodied in a processing system and a method for carrying out track work, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, side-elevational view of a processing system according to a first embodiment;

FIG. 2 is a diagrammatic, top view onto the processing system according to FIG. 1;

FIG. 3 is a diagrammatic, side-elevational view of a processing system according to a second embodiment;

FIG. 4 is a diagrammatic, side-elevational view of a processing system according to a third embodiment; and

FIG. 5 is a diagrammatic, top view onto the processing unit according to FIG. 4.

### DETAILED DESCRIPTION OF THE INVENTION

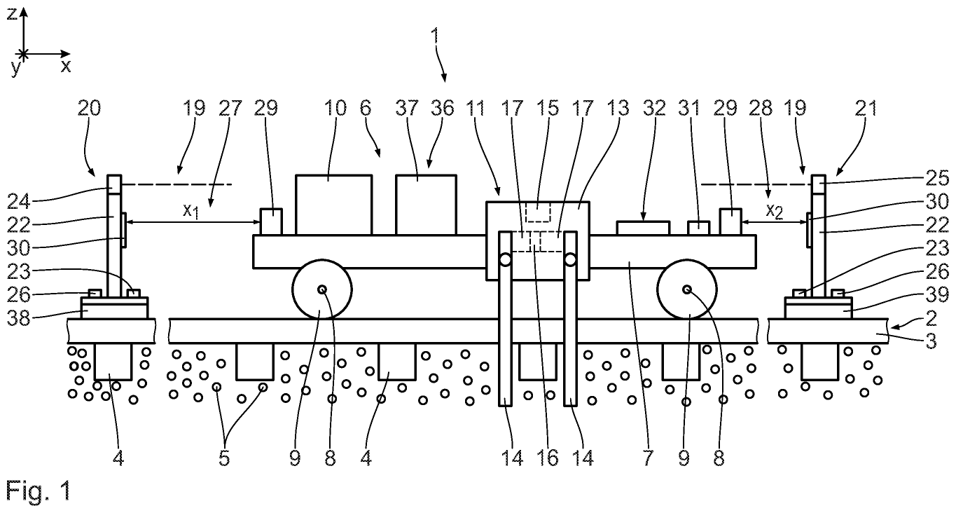

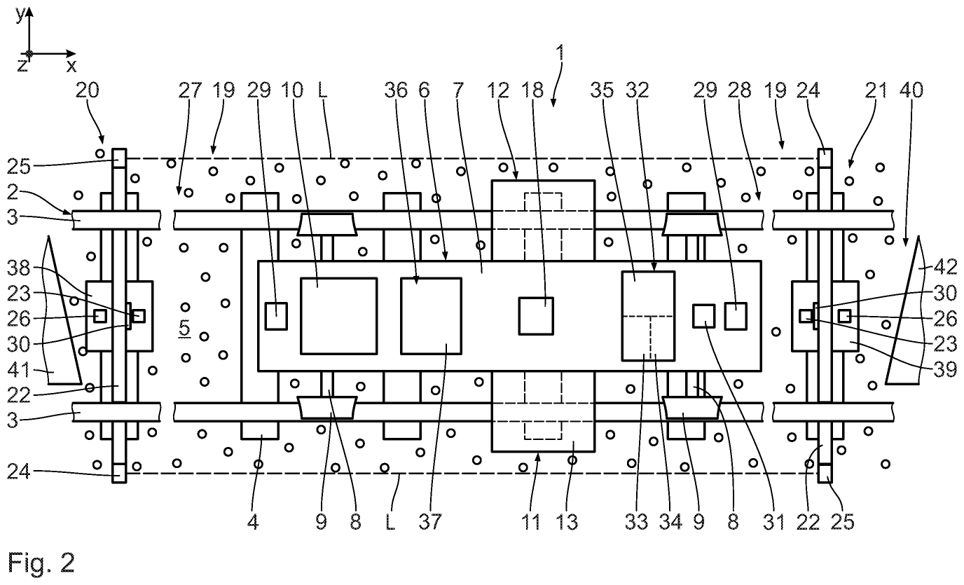

Referring now to the figures of the drawings in detail and first, particularly, to FIGS. 1 and 2 thereof, there is seen a first embodiment of the invention, which is described below. A processing system 1 serves to carry out track work on a track 2. The track 2 includes rails 3, which run in a longitudinal rail direction or a horizontal x-direction and are spaced apart in a horizontal y-direction running perpendicularly to the x-direction. The rails 3 are disposed on sleepers 4 as viewed in a vertical z-direction. The sleepers 4 are embedded in a ballast bed 5. The z-direction is perpendicular to the x-direction and the y-direction. The x-direction, the y-direction and the z-direction form a Cartesian coordinate system.

The processing system 1 includes a rail vehicle 6. The rail vehicle 6 includes a vehicle frame 7, on which two axles 8 having running wheels 9 are rotatably mounted. An electric traction drive 10 is disposed at the vehicle frame 7 for driving one of the axles 8 in rotation.

Two processing devices 11, 12 are disposed at the vehicle frame 7. The processing devices 11, 12 are configured as tamping units. The respective processing device 11, 12 includes a support frame 13 at which tamping picks 14 are mounted so that they can swivel about swivel axes. The respective support frame 13 including the tamping picks 14 can be displaced in the z-direction by using a drive 15. The tamping picks 14 can be set in an oscillating movement by using drives 16, 17 and can be adjusted towards one another in pairs. The processing devices 11, 12 are known and customary.

A sensor 18 is disposed at the vehicle frame 7 to detect the sleepers 4. The sensor 18 is configured to be optical. The sensor 18 is configured as a digital camera, for example.

The processing system 1 further includes a monitoring device 19. The monitoring device 19 serves to define and monitor a permissible working space A for the rail vehicle 6. The monitoring device 19 includes two mechanical monitoring units 20, 21. The monitoring units 20, 21 are attached to the track 2 at a distance from one another in the x-direction. The rail vehicle 6 is located between the monitoring units 20, 21.

The monitoring units 20, 21 each include a support mount 22. The respective support mount 22 is disposed, for example, centrally with respect to a sleeper 4 as viewed in the x-direction. A detector 23 is disposed on the respective support mount 22. The detector 23 detects the rail vehicle 6 when it reaches the respective monitoring unit 20, 21. The monitoring units 20, 21 thus define the working space A in the x-direction or the longitudinal rail direction and define the track section to be processed.

The respective monitoring unit 20, 21 further includes a laser beam generator and receiver 24 and a reflector 25, which are disposed at the end of the support mount 22 in the y-direction. Opposite the laser beam generator and receiver 24 of the first monitoring unit 20 in the x-direction is the reflector 25 of the second monitoring unit 21, and vice versa. This generates two light grids L which define and monitor the working space A laterally to the track 2 in the y-direction.

The respective monitoring unit 20, 21 further includes a signal transmitter 26. If the detector 23 detects the rail vehicle 6 and/or the laser beam generator and receiver 24 detects an interruption of the associated light grid L, the associated signal transmitter 26 generates an emergency stop signal.

In order to determine a position of the rail vehicle 6, the processing system 1 has a first position measuring device 27 and a second position measuring device 28. The respective position measuring device 27, 28 is configured as a laser measuring device and includes a transmitting and receiving unit 29 and an associated reflector 30. The transmitting and receiving units 29 are attached to the end of the rail vehicle 6 in the x-direction. The associated reflectors 30 are attached to the support mounts 22 of the monitoring units 20, 21. The first position measuring device 27 measures a distance x₁ between the transmitting and receiving unit 29 and the reflector 30 and thus the position of the rail vehicle 6 relative to the reflector 30. Correspondingly, the second position measuring device 28 measures a distance x₂ between the transmitting and receiving unit 29 and the reflector 30 and thus a position of the rail vehicle 6 relative to the reflector 30. The position measuring devices 27, 28 are configured to be optical and thus contactless.

The processing system 1 further includes a third position measuring device 31. The third position measuring device 31 is configured as a GPS receiver and enables an absolute position of the rail vehicle 6 to be determined. The third position measuring device 31 is attached to the rail vehicle 6.

In order to control the rail vehicle 6 depending on the determined position and the defined working space A, the processing system 1 includes a control device 32. The control device 32 is in signal communication with the position measuring devices 27, 28 and 31 and with the monitoring units 20, 21. The control device 32 includes an emitter 33 for emitting signals and a receiver 34 for receiving signals. The receiver 34 is in signal communication with the signal transmitters 26 for receiving emergency stop signals of the monitoring units 20, 21. The control device 32 is in signal communication with a control center not shown in more detail by using the emitter 33. In the event of an emergency stop signal, the control device 32 sends a corresponding signal to the control center by using the emitter 33. The control device 32 controls the traction drive 10 and the drives 15, 16, 17 of the processing devices 11, 12 by using a controller 35.

In order to supply energy, the processing system 1 includes an energy supply device 36. The energy supply device 36 includes a first energy storage device 37 for providing electrical energy. The first energy storage device 37 is disposed at the rail vehicle 6. The first energy storage device 37 supplies electrical energy to the traction drive 10, the processing devices 11, 12, the position measuring devices 27, 28, 31, the sensor 18 and the control device 32.

The energy supply device 36 further includes a second energy storage device 38 and a third energy storage device 39. The energy storage device 38 supplies electrical energy to the first monitoring unit 20, whereas the third energy storage device 39 supplies electrical energy to the second monitoring unit 21.

The processing system 1 further includes a safety device 40 having two derailing elements 41, 42. The derailing elements 41, 42 are disposed on the track 2 in such a way that the monitoring units 20, 21 are located between the derailing elements 41, 42. The safety device 40 including the derailing elements 41, 42 is thus disposed outside the working space A.

The operating principle of the processing system 1 is described below:

The processing system 1 is transported to a track section to be processed by using a transport vehicle. The transport vehicle is, for example, a road vehicle and/or a rail vehicle. The processing system 1 is then installed. By using the monitoring units 20, 21, the working space A is defined in the x-direction and the y-direction. For safety reasons, the derailing elements 41, 42 are disposed outside the working space A on the track 2. The rail vehicle 6 is then positioned in the working space A on the rails 3, for example by using a working crane.

After the monitoring units 20, 21 have been connected to the energy storage devices 38, 39, the processing program stored in the controller 35 is started. The rail vehicle 6 is then ready for driverless and unattended operation. On the basis of the position measuring signals x₁ and x₂, the rail vehicle 6 is moved by using the control device 32 in such a way that the processing devices 11, 12 are in a position above a sleeper 4. The control device 32 checks the position measuring signals x₁ and x₂ for correctness, since a specific travel path with a different sign must be equally included in the position measuring signals x₁ and x₂. In this context, the sensor 18 detects the sleeper 4, so that the position can be corrected if necessary. Subsequently, a tamping process is carried out in the usual manner by using the processing devices 11, 12. Once the tamping process is completed, the rail vehicle 6 is moved to the next sleeper 4. This procedure is repeated until the sleepers 4 disposed in the working space A and accessible by the processing devices 11, 12 have been tamped.

An absolute position of the rail vehicle 6 is determined by using the third position measuring device 31. The absolute position is transmitted to the control center by using the control device 32, for example.

In the event of a malfunction, the traction drive 10 and the processing devices 11, 12 are stopped. A failure is present if a detector 23 detects the rail vehicle 6, a light grid L is interrupted, one of the energy storage device 37, 38 or 39 is discharged and/or the position measuring devices 27, 28 transmit implausible position measuring signals x₁, x₂ to the control device 32. In the event of a malfunction, one of the monitoring units 20, 21 transmits an emergency stop signal to the control device 32 by using the associated signal generator 26. If implausible position measuring values x₁, x₂ are present in the control device, the control device 32 generates an emergency stop signal.

If the rail vehicle 6 cannot be stopped in the event of a malfunction, the rail vehicle 6 is derailed by one of the derailing elements 41, 42 when leaving the working space A by passing over one of the monitoring units 20, 21. This reliably prevents the rail vehicle 6 from moving uncontrollably on the track.

The processing system 1 thus enables track work to be carried out automatically within the working space A in a simple and safe manner.

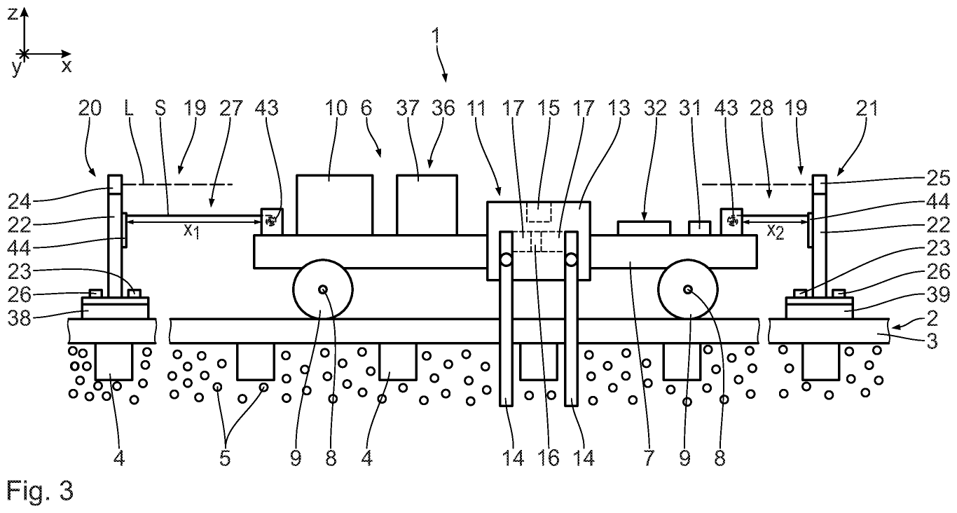

A second embodiment of the invention is described below with reference to FIG. 3. In contrast to the first embodiment, the position measuring devices 27, 28 are of mechanical configuration. The position measuring devices 27, 28 each include a measuring cable unit 43 and a fastening element 44. The measuring cable units 43 are fastened to the vehicle frame 7. The respective measuring cable S is connected to the associated fastening element 44. The respective fastening element 44 is fastened to the support mount 22 of the monitoring units 20, 21. With regard to the further construction and the further operating principle of the processing system 1, reference is made to the preceding embodiment.

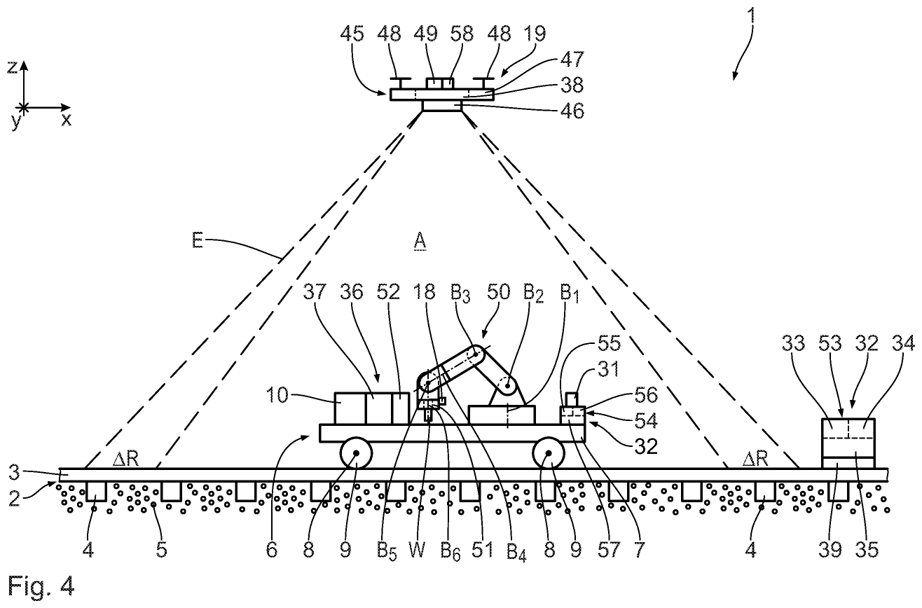

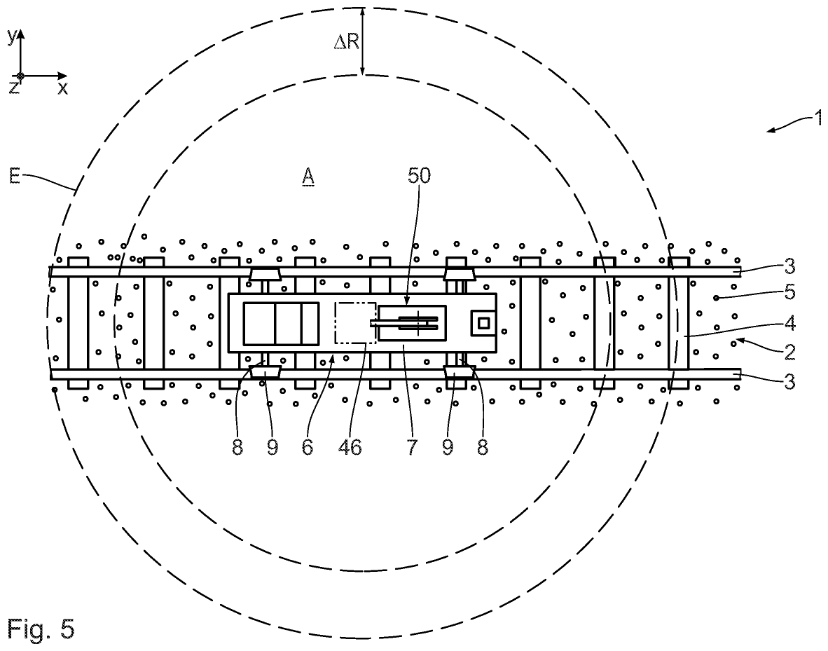

A third embodiment of the invention is described below with reference to FIGS. 4 and 5. In contrast to the preceding embodiments, the monitoring device 19 includes a flying object 45 at which an optical monitoring unit 46 is disposed. The flying object 45 is configured, for example, as a drone. The optical monitoring unit 46 includes, for example, a camera and/or an image processing unit. The flying object 45 includes a base body 47 to which rotationally drivable or rotationally driven rotors 48 are attached. The flying object 45 further includes an emitting and receiving unit 49 which is attached to the base body 47. The emitting and receiving unit 49 is in signal communication with the optical monitoring unit 46. The monitoring device 19 includes a position measuring device 58 for position determination. The position measuring device 58 is configured as a GPS receiver.

The optical monitoring unit 46 has a cone-shaped detection space E. Within the detection space E, the optical monitoring unit 46 defines the working space A. The working space A is defined in the x-direction, the y-direction, and the z-direction. For example, the working space A is defined in a conical shape. The working space A is smaller than the detection space E. In a plane which is defined by the rails 3 or in the area of the rails 3, a boundary of the working space A is spaced apart from a boundary of the detection space E by at least a dimension ΔR in each horizontal direction.

The rail vehicle 6 is disposed within the working space A on the rails 3. A processing device 50 is attached to the vehicle frame 7. The processing device 50 is configured as a multi-axis robot. The multi-axis robot is, for example, a common industrial robot. The multi-axis robot has six movement axes B₁ to B₆. The movement axis B₆ is formed by a rotationally drivable tool mounting 51. The sensor 18 is attached to the multi-axis robot. A tool W is clamped in the tool mounting 51.

In order to provide various tools W, the processing system 1 includes a tool magazine 52. The tool magazine 52 is attached to the vehicle frame 7. The processing device 50 can carry out an automatic tool change, i.e. deposit a tool W in the tool magazine 52 and remove a new tool W from the tool magazine 52.

The control device 32 includes a first control unit 53 which is disposed outside the working space A and the detection space E, and a second control unit 54 which is disposed on the vehicle frame 7. The first control unit 53 includes the emitter 33, the receiver 34, and the central controller 35. The second control unit 54 includes an emitter 55, a receiver 56, and a local controller 57.

The first control unit 53 is in signal communication with the second control unit 54 and the emitting and receiving unit 49. The local controller 57 controls the rail vehicle 6 and is in signal communication with the traction drive 10, the processing device 50, the sensor 18 and the position measuring device 31.

The energy storage device 38 is disposed at the base body 47 to supply energy to the flying object 45. The first control unit 53 is connected to the third energy storage device 39.

After the processing system 1 has been transported to the track section to be processed, the rail vehicle 6 is disposed on the rails 3 and the first control unit 53 is positioned at a sufficient distance next to the track 2. A control program stored in the central controller 35 is then started. By using the control program, the monitoring device 19 is put into operation. For this purpose, the flying object 45 is started and positioned in the z-direction above the rail vehicle 6. The optical monitoring unit 46 defines the working space A within the detection space E and detects the rail vehicle 6 within the working space. Then, the control program starts a processing program which is stored in the local controller 57. By using the processing program, the rail vehicle or the processing device 50 carries out the intended track work.

In the event of a malfunction, the traction drive 10 and the processing device 50 are stopped. A malfunction occurs when the rail vehicle 6 leaves the defined working space A, when a person and/or an object violates the working space A, when the position measuring device 31 and the optical monitoring unit 46 in conjunction with the position measuring device 58 determine positions of the rail vehicle 6 that deviate from one another, and/or when one of the energy storage devices 37, 38 or 39 is discharged.

In the event of a sudden change in the flight attitude or flight position of the flying object 45, for example as a result of environmental influences, the detection space E and thus the defined working space A changes. The distance ΔR is selected in such a way that changes in the flight attitude or flight position, insofar as these cannot be directly compensated for, do not cause the changed working space A to extend beyond the original detection space E. This ensures a high level of safety when monitoring the working space A.

When carrying out track work on a long track section, the flying object 45 is moved synchronously with the rail vehicle 6 so that the working space A is defined dynamically. The working space A thus moves along with the rail vehicle 6. The safety of the processing system 1 is ensured by detecting a violation of the working space A by a person and/or an object.

In the event of a malfunction, an emergency stop signal is generated by the control device 32, in particular by the first control unit 53, and transmitted to the second control unit 54 and the control center.

With regard to the further construction and the further operating principle, reference is made to the preceding embodiments.

In general, the following applies:

The features of the embodiments can be combined with each other as desired.

The operation of the processing system 1 can be monitored by a supervisor. An emergency stop button can be disposed outside the working space A so that the supervisor can stop the processing system 1 at any time by pressing the emergency stop button.

The optical monitoring unit 46 may include a camera, a laser scanner and/or a radar. For detection, the rail vehicle 6 may have a marking that can be detected unambiguously by the optical monitoring unit 46.

The distance ΔR can be changed depending on the environmental influences or the weather situation. The monitoring device 19 can be provided with data on the weather situation, for example by using the control device 32.

1. A processing system for carrying out track work, the processing system comprising:
a rail vehicle including at least one processing device;
a monitoring device for defining and monitoring a permissible working space for said rail vehicle;
at least one position measuring device for determining a position of said rail vehicle; and
a control device for controlling said rail vehicle in dependence on the determined position and the defined working space.

2. The processing system according to claim 1, wherein said rail vehicle is configured for at least one of driverless operation or unattended operation.

3. The processing system according to claim 1, which further comprises at least one sensor for controlling said at least one processing device.

4. The processing system according to claim 1, wherein said at least one processing device is configured as a multi-axis robot.

5. The processing system according to claim 1, wherein said at least one position measuring device has a non-contact configuration.

6. The processing system according to claim 1, wherein said at least one position measuring device has a mechanical configuration.

7. The processing system according to claim 1, wherein said at least one position measuring device includes a first position measuring device for providing a first position measuring signal and a second position measuring device for providing a second position measuring signal.

8. The processing system according to claim 1, wherein said monitoring device includes at least two monitoring units each configured to be disposed on a respective side of said rail vehicle.

9. The processing system according to claim 1, wherein said monitoring device includes at least one optical monitoring unit.

10. The processing system according to claim 1, wherein said monitoring device includes at least one flying object.

11. The processing system according to claim 1, which further comprises a safety device for mechanically stopping said rail vehicle outside of said working space.

12. The processing system according to claim 1, which further comprises a tool magazine for providing tools for said at least one processing device.

13. The processing system according to claim 1, which further comprises an energy supply device for supplying energy.

14. The processing system according to claim 1, wherein said control device includes at least one of at least one emitter for emitting signals or at least one receiver for receiving signals.

15. A method for carrying out track work, the method comprising the following steps:
providing a processing system for carrying out track work, the processing system including:
a rail vehicle including at least one processing device,
a monitoring device for defining and monitoring a permissible working space for the rail vehicle,
at least one position measuring device for determining a position of the rail vehicle, and
a control device for controlling the rail vehicle in dependence on the determined position and the defined working space;
using the monitoring device to define the working space; and
moving the rail vehicle and carrying out track work within the defined working space by:
using the at least one position measuring device to determine the position of the rail vehicle, and
using the control device to control the rail vehicle in dependence on the determined position and the defined working space.
